(19) United States
(12) Patent Application Publication
(10) Pub. No.: US 2018/0171781 A1
(43) Pub. Date: Jun. 21, 2018

(54) INTEGRATED COMPUTATIONAL ELEMENTS INCORPORATING A STRESS RELIEF LAYER

(71) Applicant: Halliburton Energy Services, Inc., Houston, CA (US)

(72) Inventors: James M. PRICE, Spring, TX (US); David L. PERKINS, The Woodlands, TX (US)

(73) Assignee: Halliburton Energy Services, Inc., Houston, TX (US)

(21) Appl. No.: 15/735,541

(22) PCT Filed: Jul. 30, 2015
(86) PCT No.: PCT/US15/42956

§ 371 Date: Dec. 11, 2017

(51) Int. Cl. E21B 47/09; G01V 8/14; G01N 21/41

(52) U.S. Cl. CPC E21B 47/0905; G01N 2021/4126; G01N 21/41; G01V 8/14

(57) ABSTRACT

An optical computing device includes an electromagnetic radiation source that emits electromagnetic radiation to optically interact with a substance and an integrated computational element (ICE) core. The ICE core includes a substrate, and a first plurality of thin films alternatingly deposited on the substrate with a second plurality of thin films via a thin film deposition process, wherein the first plurality of thin films is made of a high refractive index material and the second plurality of thin films is made of low refractive index material. A stress relief layer is deposited on the substrate via the thin film deposition process and interposes the substrate and a first layer of the first plurality of thin films. A detector is positioned to receive modified electromagnetic radiation that has optically interacted with the substance and the ICE core and generate an output signal indicative of the characteristic of the substance.

### BACKGROUND

Optical computing devices can be used to analyze and monitor sample substances in real time. Such optical computing devices will often employ a light source that emits electromagnetic radiation that reflects from or is transmitted through the sample and optically interacts with an optical processing element to determine quantitative and/or qualitative values of one or more physical or chemical properties of the substance being analyzed. The optical processing element may be, for example, an integrated computational element (ICE) core. Each ICE core can be designed to operate over a continuum of wavelengths in the electromagnetic spectrum from the UV to mid-infrared (MIR) ranges, or any sub-set of that region. Electromagnetic radiation that optically interacts with the sample substance is changed and processed by the ICE core so as to be measured by a detector. The output of the detector can be correlated to a physical or chemical property of the substance being analyzed.

An ICE core typically includes a plurality of optical thin film layers consisting of various materials whose index of refraction and size (e.g., thickness) may vary between each layer. An ICE core design refers to the substrate, the number and thickness of the respective optical thin film layers, and the refractive indices of each optical thin film layer of the ICE core. The optical thin film layers may be strategically deposited and sized to interfere constructively or destructively at desired wavelengths to provide an encoded pattern specifically for the purpose of interacting with light and providing an optical computational operation, which allows for the prediction of a chemical or material property. Accordingly, an ICE core design will exhibit a transmission function that is weighted with respect to wavelength. As a result, the output light intensity from the ICE core conveyed to the detector may be related to the physical or chemical property of interest for the substance.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 illustrates an exemplary integrated computational element core.

FIGS. 2A and 2B are top down scanning electron microscope images of two different TiO₂ optical thin films having a thickness of about 150 nm.

FIG. 3 is a graph that depicts optical constants for TiO₂ deposited on Si as compared to TiO₂ deposited on Al₂O₃.

FIG. 4 is a schematic flowchart of a method of fabricating an ICE core.

FIG. 5 is a schematic diagram of an exemplary optical computing device that uses an ICE core fabricated according to the methods described herein.

FIG. 6 is an exemplary well drilling system that may employ the optical computing device of FIG. 5.

FIG. 7 is an exemplary wireline logging system that may employ the optical computing device of FIG. 5.

### DETAILED DESCRIPTION

The present disclosure is related to optical processing elements and, in particular, methods of manufacturing or fabricating an integrated computational element core for use in an optical computing device.

The present disclosure describes improved methods of manufacturing optical processing elements, such as integrated computational element (ICE) cores. An example ICE core may comprise a plurality of alternating thin film layers deposited on a substrate, where the alternating layers exhibit high and low indices of refraction, respectively. A stress relief layer may interpose the substrate and the alternating high and low index of refraction layers to provide an amorphous pseudo-substrate layer for the first layer such that all the subsequent layers of a similar refractive index (high or low) may exhibit the same growth rate, crystal structure, and optical properties. In some cases, the first layer may exhibit a high refractive index, but in other cases, the first layer may exhibit a low refractive index. Use of the stress relief layer may prove advantageous in scenarios where a lattice mismatch (i.e., large difference in crystal lattice spacing) may exist between the respective materials of the substrate and the first layer. More particularly, the inclusion of a thin, optically transparent stress relief layer may be provided such that the physical interaction between the substrate and the first layer does not affect the designed optical transmission profile of the ICE core derived from the ICE core design.

The methods disclosed herein may be suitable for fabricating optical processing elements (e.g., ICE cores) for use in the oil and gas industry, such as for monitoring and detecting oil/gas-related substances (e.g., hydrocarbons, drilling fluids, completion fluids, treatment fluids, etc.). It will be appreciated, however, that the methods described herein are equally applicable to fabricating ICE cores for use in other technology fields including, but not limited to, the food industry, the paint industry, the mining industry, the agricultural industry, the medical and pharmaceutical industries, the automotive industry, the cosmetics industry, water treatment facilities, and any other field where it may be desired to monitor substances in real time.

As used herein, the term “characteristic” or “characteristic of interest” refers to a chemical, mechanical, or physical property of a substance or a sample of the substance. The characteristic of a substance may include a quantitative or qualitative value of one or more chemical constituents or compounds present therein or any physical property associated therewith. Such chemical constituents and compounds may be referred to herein as “analytes.” Illustrative characteristics of a substance that can be analyzed with the help of the optical processing elements described herein can include, for example, chemical composition (e.g., identity and concentration in total or of individual components), phase presence (e.g., gas, oil, water, etc.), impurity content, pH, alkalinity, viscosity, density, ionic strength, total dissolved solids, salt content (e.g., salinity), porosity, opacity, bacteria content, total hardness, transmittance, state of matter (solid, liquid, gas, emulsion, mixtures thereof, etc.), and the like.

As used herein, the term “substance,” or variations thereof, refers to at least a portion of matter or material of interest to be tested or otherwise evaluated with the help of the optical processing elements and optical computing devices described herein. The substance may be any fluid capable of flowing, including particulate solids, liquids, gases (e.g., air, nitrogen, carbon dioxide, argon, helium, methane, ethane, butane, and other hydrocarbon gases, hydrogen sulfide, and combinations thereof), slurries, emulsions, powders, muds, glasses, mixtures, combinations thereof, and may include, but is not limited to, aqueous fluids (e.g., water, brines, etc.), non-aqueous fluids (e.g., organic compounds, hydrocarbons, oil, a refined component of oil, petrochemical products, and the like), acids, surfactants, biocides, bleaches, corrosion inhibitors, foamers and foaming agents, breakers, scavengers, stabilizers, clarifiers, detergents, treatment fluids, fracturing fluids, formation fluids, or any oilfield fluid, chemical, or substance commonly found in the oil and gas industry. The substance may also refer to solid materials such as, but not limited to, rock formations, concrete, solid wellbore surfaces, pipes or flow lines, and solid surfaces of any wellbore tool or projectile (e.g., balls, darts, plugs, etc.).

As used herein, the term “electromagnetic radiation” refers to radio waves, microwave radiation, terahertz, infrared and near-infrared radiation, visible light, ultraviolet light, X-ray radiation and gamma ray radiation.

As used herein, the term “optically interact” or variations thereof refers to the reflection, transmission, scattering, diffraction, or absorption of electromagnetic radiation either on, through, or from an optical processing element (e.g., an integrated computational element) or a substance being analyzed with the help of the optical processing element. Accordingly, optically interacted light refers to electromagnetic radiation that has been reflected, transmitted, scattered, diffracted, or absorbed by, emitted, or re-radiated, for example, using an optical processing element, but may also apply to optical interaction with a substance.

As used herein, the term “optical computing device” refers to an optical measurement device designed to receive an input of electromagnetic radiation associated with a substance and produce an output of electromagnetic radiation from an optical processing element arranged within or otherwise associated with the optical computing device. The optical processing element may be, for example, an integrated computational element (ICE) core. The electromagnetic radiation that optically interacts with the optical processing element is changed so as to be readable by a detector, such that an output of the detector can be correlated to a particular characteristic of the substance being analyzed. The output of electromagnetic radiation from the optical processing element can be reflected, transmitted, and/or dispersed electromagnetic radiation. Whether the detector analyzes reflected, transmitted, or dispersed electromagnetic radiation may be dictated by the structural parameters of the optical computing device as well as other considerations known to those skilled in the art. In addition, emission and/or scattering of the fluid, for example via fluorescence, luminescence, Raman, Mie, and/or Raleigh scattering, can also be monitored by optical computing devices.

As indicated above, the present disclosure provides improved methods of manufacturing or fabricating optical processing elements, such as ICE cores, for use in optical computing devices. ICE cores are sometimes referred to as multivariate optical elements (MOEs). In operation, an ICE core is capable of distinguishing electromagnetic radiation related to a characteristic of interest of a substance from electromagnetic radiation related to other components of the substance.

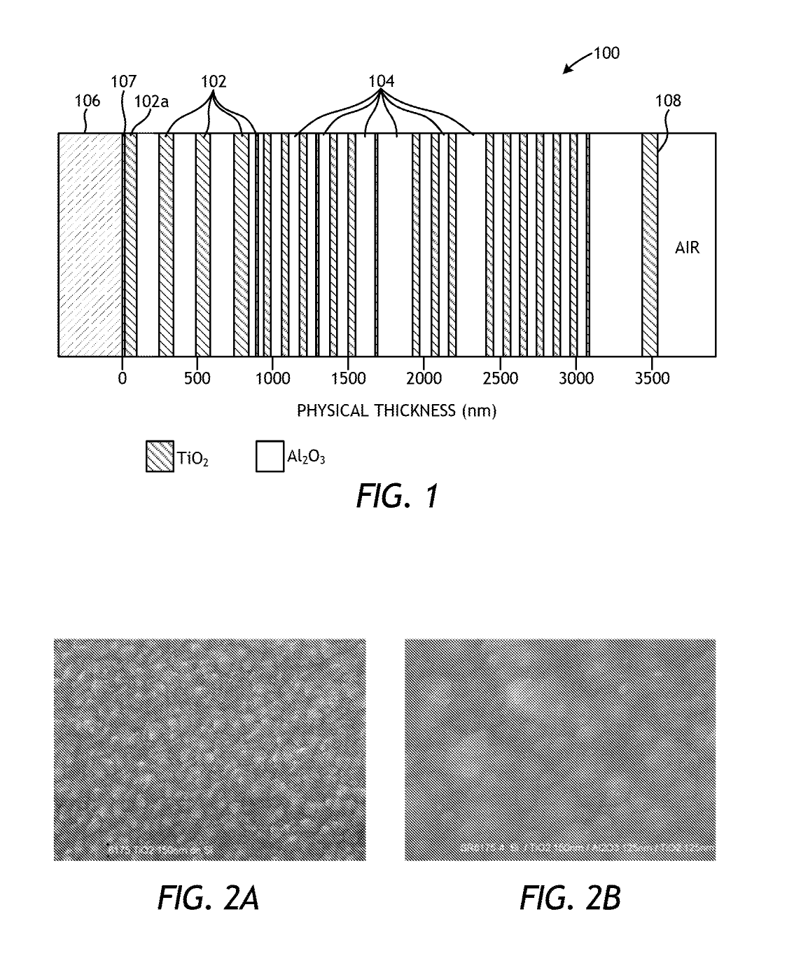

Referring to FIG. 1, illustrated is an exemplary ICE core 100 that may be fabricated using the presently disclosed methods, according to one or more embodiments. As illustrated, the ICE core 100 may include a plurality of alternating thin film layers 102 and 104, such as titanium dioxide (TiO₂) and aluminum oxide (Al₂O₃), respectively. In general, these layers 102, 104 consist of materials whose index of refraction is high and low, respectively. In some embodiments, however, the layers 102, 104 may consist of materials whose index of refraction is low and high, respectively without departing from the scope of this disclosure. Other examples of materials that may be used as the layers 102, 104 include, but are not limited to, niobia and niobium, germanium and germania, MgF, SiO, SiO₂, Si, HfO₂, ZrO₂, Ta₂O₅, ternary or tertiary alloys of the foregoing (e.g., HfTaO₂, HfSiO, etc.) and other high and low index of refraction materials known in the art. In at least one embodiment, one or more of the layers 102, 104 may be comprised of more than one of the aforementioned materials. The layers 102, 104 may be strategically deposited on a substrate 106. In some embodiments, the substrate 106 is made of silicon (Si). In other embodiments, however, the substrate 106 may comprise other types of optical substrates, such as an optical glass (e.g., BK-7 optical glass), silica, sapphire, germanium, zinc selenide, zinc sulfide, diamond, ceramics, or various plastics such as polycarbonate, polymethylmethacrylate (PMMA), polyvinylchloride (PVC), combinations thereof, and the like.

The ICE core 100 may further include a stress relief layer 107 that interposes the substrate 106 and the alternating high and low index of refraction layers 102, 104. More particularly, the stress relief layer 107 may interpose the substrate 106 and a first layer 102, shown in FIG. 1 as layer 102a. In some embodiments, the first layer 102a may exhibit a high refractive index, but in other embodiments, the first layer 102a may exhibit a low refractive index. As will be described and discussed in greater detail below, the stress relief layer 107 may provide an amorphous pseudo-substrate layer for the first layer 102a such that all the subsequently deposited layers 102 of a similar refractive index (high or low), including the first layer 102a, may exhibit the same growth rate, crystal structure, and optical properties. Use of the stress relief layer 107 may prove advantageous in scenarios where a lattice mismatch (i.e., large difference in crystal lattice spacing) may exist between the respective materials of the substrate 106 and the first layer 102a. Such lattice mismatches could negatively impact the crystal structure of the first layer 102a, and thereby alter the preconfigured transmission profile of the ICE core 100. According to embodiments of the present disclosure, the stress relief layer 107 may prove advantageous in maintaining the optical properties, and growth rate of the first layer 102a and the remaining layers 102 of a similar refractive index (high or low) at a constant value and thereby resulting in a more predictive (performance and fabricated) ICE core 100.

At the opposite end (e.g., opposite the substrate 106 in FIG. 1), the ICE core 100 may include a layer 108 that is generally exposed to the environment of the device or installation. The number of layers 102, 104 and the thickness of each layer 102, 104 are determined from the spectral attributes acquired from a spectroscopic analysis of a particular characteristic of a given substance being analyzed using a conventional spectroscopic instrument. The spectrum of interest of a given characteristic typically includes any number of different wavelengths.

It should be understood that the ICE core 100 depicted in FIG. 1 does not in fact represent any particular ICE core configured to detect a specific characteristic of a given substance, but is provided for purposes of illustration only. Consequently, the number of layers 102, 104 and their relative thicknesses, as shown in FIG. 1, bear no correlation to any particular substance or characteristic thereof. Nor are the layers 102, 104 and their relative thicknesses necessarily drawn to scale, and therefore should not be considered limiting of the present disclosure.

In some embodiments, the material of each layer 102, 104 can be doped or two or more materials can be combined in a manner to achieve the desired optical characteristic. In addition to solids, the exemplary ICE core 100 may also contain liquids and/or gases, optionally in combination with solids, in order to produce a desired optical characteristic. In the case of gases and liquids, the ICE core 100 can contain a corresponding vessel (not shown), which houses the gases or liquids. Exemplary variations of the ICE core 100 may also include holographic optical elements, gratings, piezoelectric, light pipe, and/or acousto-optic elements, for example, that can create transmission, reflection, and/or absorptive properties of interest.

The multiple layers 102, 104 may exhibit different complex refractive indices, where the complex refractive index includes both real ‘n’ and imaginary ‘k’ components of the refractive index. By properly selecting the materials of the layers 102, 104 and their relative thickness and spacing, the ICE core 100 may be configured to selectively transmit or reflect predetermined fractions of electromagnetic radiation at different wavelengths. Each wavelength is given a predetermined weighting or loading factor. The thickness and spacing of the layers 102, 104 may be determined using a variety of approximation methods from the spectrum of the characteristic or analyte of interest. These methods may include inverse Fourier transform (IFT) of the optical transmission spectrum and structuring the ICE core 100 as the physical representation of the IFT. The approximations convert the IFT into a structure based on known materials with constant refractive indices.

The weightings that the layers 102, 104 of the ICE core 100 apply at each wavelength are set to the regression weightings described with respect to a known equation, data, or spectral signature. For instance, when electromagnetic radiation interacts with a substance, unique physical and chemical information about the substance is encoded in the electromagnetic radiation that is reflected from, transmitted through, or radiated from the substance. This information is often referred to as the spectral “fingerprint” of the substance. The ICE core 100 may operate as a processor that performs the dot product of the received electromagnetic radiation and the wavelength dependent transmission function of the ICE core 100. The wavelength dependent transmission function of the ICE core 100 is dependent on the material refractive index of each layer, the number of layers 102, 104 and thickness of each layer 102, 104. As a result, the output light intensity of the ICE core 100 is related to the characteristic or analyte of interest.

As further explanation, accurately determining the regression vector of the characteristic of interest in the sample substance provides a means for an optical computing device to determine or otherwise calculate a concentration of said characteristic in the sample substance. The regression vector for each characteristic may be determined using standard procedures that will be familiar to one having ordinary skill in the art. For example, analyzing the spectrum of the sample substance may include determining a dot product of the regression vector for each characteristic of the sample substance being analyzed. As one of ordinary skill in art will recognize, a dot product of a vector is a scalar quantity (i.e., a real number). While the dot product value is believed to have no physical meaning by itself (e.g., it may return a positive or negative result of any magnitude), comparison of the dot product value of a sample substance with dot product values obtained for known reference standards and plotted in a calibration curve may allow the sample substance dot product value to be correlated with a concentration or value of a characteristic, thereby allowing unknown sample substances to be accurately analyzed.

To determine the dot product, the regression coefficient of the regression vector at a given wavelength is multiplied by the spectral intensity at the same wavelength. This process is repeated for all wavelengths analyzed, and the products are summed over the entire wavelength range to yield the dot product. Those skilled in the art will recognize that two or more characteristics may be determined from a single spectrum of the sample substance by applying a corresponding regression vector for each characteristic.

In practice, it is possible to derive information from electromagnetic radiation interacting with a sample substance by, for example, separating the electromagnetic radiation from several samples into wavelength bands and performing a multiple linear regression of the band intensity against a characteristic of interest determined by another measurement technique for each sample substance. The measured characteristic may be expressed and modeled by multiple linear regression techniques that will be familiar to one having ordinary skill in the art. Specifically, if y is the measured value of the concentration or characteristic, y may be expressed as in Equation 1:

y=a₀+a₁w₁+a₂w₂+a₃w₃+a₄w₄+ . . . +aₙwₙ Equation(1)

where ‘a’ is a constant determined by the regression analysis and ‘w’ is the light intensity for each wavelength band. Depending on the circumstances, the estimate obtained from Equation (1) may be inaccurate, for example, due to the presence of other characteristics within the sample substance that may affect the intensity of the wavelength bands. A more accurate estimate may be obtained by expressing the electromagnetic radiation in terms of its principal components.

To obtain the principal components, spectroscopic data is collected for a variety of similar sample substances using the same type of electromagnetic radiation. For example, following exposure to each sample substance, the electromagnetic radiation may be collected and the spectral intensity at each wavelength may be measured for each sample substance. This data may then be pooled and subjected to a linear-algebraic process known as singular value decomposition (SVD) in order to determine the principal components. Use of SVD in principal component analysis will be well understood by one having ordinary skill in the art. Briefly, however, principal component analysis is a dimension reduction technique that takes ‘m’ spectra with ‘n’ independent variables and constructs a new set of eigenvectors that are linear combinations of the original variables. The eigenvectors may be considered a new set of plotting axes. The primary axis, termed the first principal component, is the vector that describes most of the data variability. Subsequent principal components describe successively less sample variability, until the higher order principal components essentially describe only spectral noise.

Typically, the principal components are determined as normalized vectors. Thus, each component of an electromagnetic radiation sample may be expressed as xₙzₙ, where xₙ is a scalar multiplier and zₙ is the normalized component vector for the n^{th} component. That is, zₙ is a vector in a multi-dimensional space where each wavelength is a dimension. Normalization determines values for a component at each wavelength so that the component maintains its shape and the length of the principal component vector is equal to one. Thus, each normalized component vector has a shape and a magnitude so that the components may be used as the basic building blocks of any electromagnetic radiation sample having those principal components. Accordingly, each electromagnetic radiation sample may be described by a combination of the normalized principal components multiplied by the appropriate scalar multipliers, as set forth in Equation (2):

x₁z₁+x₂z₂+ . . . +xₙzₙ Equation(2)

The scalar multipliers xₙ may be considered the “magnitudes” of the principal components in a given electromagnetic radiation sample when the principal components are understood to have a standardized magnitude as provided by normalization.

Because the principal components are orthogonal, they may be used in a relatively straightforward mathematical procedure to decompose an electromagnetic radiation sample into the component magnitudes, which may accurately describe the data in the original electromagnetic radiation sample. Since the original electromagnetic radiation sample may also be considered a vector in the multi-dimensional wavelength space, the dot product of the original signal vector with a principal component vector is the magnitude of the original signal in the direction of the normalized component vector. That is, it is the magnitude of the normalized principal component present in the original signal. This is analogous to breaking a vector in a three dimensional Cartesian space into its X, Y and Z components. The dot product of the three-dimensional vector with each axis vector, assuming each axis vector has a magnitude of 1, gives the magnitude of the three dimensional vector in each of the three directions. The dot product of the original signal and some other vector that is not perpendicular to the other three dimensions provides redundant data, since this magnitude is already contributed by two or more of the orthogonal axes.

Because the principal components are orthogonal to each other, the dot product of any principal component with any other principal component is zero. Physically, this means that the components do not interfere with each other. If data is altered to change the magnitude of one component in the original electromagnetic radiation signal, the other components remain unchanged. In the analogous Cartesian example, reduction of the X component of the three dimensional vector does not affect the magnitudes of the Y and Z components.

Principal component analysis provides the fewest orthogonal components that can accurately describe the data carried by the electromagnetic radiation samples. Thus, in a mathematical sense, the principal components are components of the original electromagnetic radiation that do not interfere with each other and that represent the most compact description of the spectral signal. Physically, each principal component is an electromagnetic radiation signal that forms a part of the original electromagnetic radiation signal. Each principal component has a shape over some wavelength range within the original wavelength range. Summing the principal components may produce the original signal, provided each component has the proper magnitude, whether positive or negative.

The principal components may comprise a compression of the information carried by the total light signal. In a physical sense, the shape and wavelength range of the principal components describe what information is in the total electromagnetic radiation signal, and the magnitude of each component describes how much of that information is present. If several electromagnetic radiation samples contain the same types of information, but in differing amounts, then a single set of principal components may be used to describe (except for noise) each electromagnetic radiation sample by applying appropriate magnitudes to the components. The principal components may be used to provide an estimate of the characteristic of the sample substance based upon the information carried by the electromagnetic radiation that has interacted with that sample substance. Differences observed in spectra of sample substances having varying quantities of an analyte or values of a characteristic may be described as differences in the magnitudes of the principal components. Thus, the concentration of the characteristic may be expressed by the principal components according to Equation (3) in the case where four principal components are used:

y=a₀+a₁x₁+a₂x₂+a₃x₃+a₄x₄ Equation(3)

where ‘y’ is a concentration or value of a characteristic, each a is a constant determined by the regression analysis, and x₁, x₂, x₃ and x₄ are the first, second, third, and fourth principal component magnitudes, respectively. Equation (3) may be referred to as a regression vector. The regression vector may be used to provide an estimate for the concentration or value of the characteristic for an unknown sample.

Regression vector calculations may be performed by a computer, based on spectrograph measurements of electromagnetic radiation by wavelength. The spectrograph system spreads the electromagnetic radiation into its spectrum and measures the spectral intensity at each wavelength over the wavelength range. Using Equation (3), the computer may read the intensity data and decompose the electromagnetic radiation sample into the principal component magnitudes xₙ by determining the dot product of the total signal with each component. The component magnitudes are then applied to the regression equation to determine a concentration or value of the characteristic.

To simplify the foregoing procedure, however, the regression vector may be converted to a form that is a function of wavelength so that only one dot product is determined. Each normalized principal component vector zₙ has a value over all or part of the total wavelength range. If each wavelength value of each component vector is multiplied by the regression constant and corresponding to the component vector, and if the resulting weighted principal components are summed by wavelength, the regression vector takes the form of Equation (4):

y=a₀+b₁u₁+b₂u₂+ . . . +bₙuₙ Equation(4)

where a₀ is the first regression constant from Equation (3), bₙ is the sum of the multiple of each regression constant aₙ from Equation (3) and the value of its respective normalized regression vector at wavelength ‘n’, and uₙ is the intensity of the electromagnetic radiation at wavelength ‘n’. Thus, the new constants define a vector in wavelength space that directly describes a concentration or characteristic of a sample substance. The regression vector in the form of Equation (4) represents the dot product of an electromagnetic radiation sample with this vector.

Normalization of the principal components provides the components with an arbitrary value for use during the regression analysis. Accordingly, it is very unlikely that the dot product value produced by the regression vector will be equal to the actual concentration or characteristic value of a sample substance being analyzed. The dot product result is, however, proportional to the concentration or characteristic value. As discussed above, the proportionality factor may be determined by measuring one or more known calibration samples by conventional means and comparing the result to the dot product value of the regression vector. Thereafter, the dot product result can be compared to the value obtained from the calibration standards in order to determine the concentration or characteristic of an unknown sample being analyzed.

With continued reference to FIG. 1, the ICE core 100 may be fabricated using a thin film deposition process that sequentially deposits on the substrate 106 the alternating layers 102, 104 of high and low refractive index materials (including the first layer 102a). Suitable thin film deposition processes that may be used to fabricate the ICE core include, but are not limited to, atomic layer deposition, physical vapor deposition, chemical vapor deposition, sputtering (e.g., reactive magnetron), pulsed laser deposition, chemical solution deposition, plasma enhanced chemical vapor deposition, cathodic arc deposition, electrohydrodynamic deposition (i.e., electrospray deposition), electron beam deposition, ion-assisted electron-beam deposition, electrolytic plating, electroless plating, thermal evaporation, chemical evaporation, and molecular beam epitaxy. In at least one specific embodiment, the thin film deposition process used to fabricate the ICE core is atomic layer deposition (ALD). In ALD processing, the substrate 106 is first be arranged in an ALD reaction chamber and the layers 102, 104 are then sequentially (i.e., consecutively) deposited or “grown” on the substrate 106 to respective desired thicknesses. Briefly, this process includes introducing a first gaseous compound or “precursor” into the ALD reaction chamber to chemically bond to the substrate 106. The ALD reaction chamber may then be purged or evacuated to remove any non-reacted precursors and/or gaseous reaction by-products. A second precursor may then be introduced into the ALD reaction chamber to chemically react to the substrate-bonded precursor of the previous cycle to form a monolayer. The ALD reaction chamber may then again be purged or evacuated to remove any non-reacted precursors and/or gaseous reaction by-products of the second precursor. The foregoing steps may then be repeated as many times as required for the desired number of layers 102, 104 and the desired thickness of each layer 102, 104.

Due to self-terminating reactions inherent in ALD processing, ALD is characterized as a surface-controlled process, where the predominant process parameters of control include the precursors (and their flow rates), the substrate 106, and the ambient temperature inside the ALD reaction chamber. Moreover, because of the surface control that is inherent in ALD processes, the resulting layers 102, 104 deposited on the substrate 106 are extremely conformal.

The design process for a given ICE core (e.g., the ICE core 100) uses the contrasting refractive indices of two alternating high and low refractive index materials (e.g., the layers 102, 104, respectively) to find a desired transmission profile for the given ICE core. If a material exhibiting different optical properties than the alternating successive materials is present in the thin film stack, a new design procedure would have to be implemented and the fabrication process modified to accommodate a more complicated design. In at least one embodiment, for instance, the substrate 106 may comprise silicon (Si) and the materials for the high and low index layers 102, 104 may comprise TiO₂ and Al₂O₃, respectively. However, recent process development for TiO₂ has identified how successive layering of TiO₂ on Al₂O₃ exhibits a different growth rate, crystal structure, and optical properties as compared to a first TiO₂ layer deposited on a Si substrate 106. A summary of the two different TiO₂ characteristics is illustrated in Table 1 below:

TABLE 1

| TiO₂ Deposited On: | Growth Rate: | Crystal Structure: | R.I. @1500 nm |
|---|---|---|---|
| Si Substrate | 0.5 A/cycle | Anatase | 2.39 |
| Al₂O₃ | 0.38 A/cycle | Amorphous | 2.41 |

As noted in Table 1, the resulting growth rate of TiO₂ as deposited on a Si substrate 106 is different than the resulting growth rate of TiO₂ as deposited on Al₂O₃, thereby resulting in different crystal structures; i.e., anatase as opposed to amorphous, respectively. As will be appreciated, the crystal structure of the various layers 102, 104 governs the electronic structure and the optical properties of the ICE core, such as its refractive index (R.I.). As indicated in Table 1, the refractive index of TiO₂ as deposited on a Si substrate 106 is different than the refractive index of TiO₂ as deposited on Al₂O₃. As will be appreciated, the different optical properties of TiO₂ depending on its underlying material may complicate the procedure for designing and fabricating a given ICE core.

Referring now to FIGS. 2A and 2B, illustrated are top down scanning electron microscope (SEM) images of two different TiO₂ optical thin films having a thickness of about 150 nm. More particularly, FIG. 2A depicts an SEM image of a TiO₂ optical thin film as grown on Si, while FIG. 2B depicts an SEM image of a TiO₂ optical thin film as grown on Al₂O₃. As depicted, the SEM images indicate that the TiO₂ optical thin film grown on Si (FIG. 2A) exhibits a much rougher surface with considerably larger and denser crystal grains as compared to the same material grown on Al₂O₃ (FIG. 2B). This can be attributed to the epitaxial nature of growth inherent for ALD where the TiO₂ is conforming to the underlying crystal lattice structure. In the case of Si, the crystal lattice mismatch (between anatase TiO₂ and crystalline Si) causes considerable stress in the TiO₂ thin film, thereby resulting in larger and denser crystal grains. In contrast, when TiO₂ is deposited on an amorphous substrate such as Al₂O₃, the stress is considerably less and so is the crystal grain size and distribution.

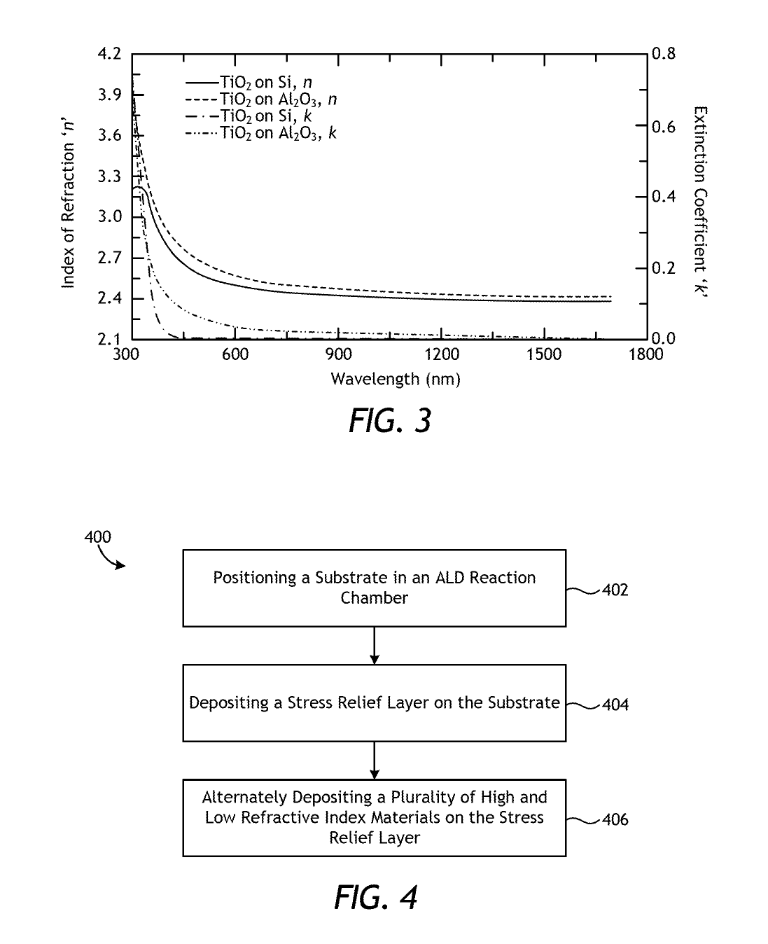

The phenomenon shown in the SEM images of FIGS. 2A and 2B may also affect the optical properties of the TiO₂. Referring to FIG. 3, for example, illustrated is a graph that depicts optical constants for TiO₂ as deposited on Si as compared to TiO₂ deposited on Al₂O₃. As depicted in the graph, TiO₂ as deposited on Al₂O₃ exhibits both a higher index of refraction (‘n’) and extinction coefficient (‘k’), also referred to as absorption coefficient. Accordingly, there is a discernible difference in refractive index depending on whether TiO₂ is grown on Si or grown on Al₂O₃.

In order to avoid both these crystal structure and optical differences, embodiments of the present disclosure include depositing the stress relief layer 107 (FIG. 1) on the substrate 106 during the above-described ALD deposition process and prior to depositing the remaining layers 102, 104 (including the first layer 102a). The stress relief layer 107 may comprise an optically thin layer of Al₂O₃ that interposes the substrate 106 and the first layer 102a (either high or low refractive index). As used herein, the term “optically thin” refers to an optical film thickness that is small enough such that it does not significantly impact the desired transmission profile for a given ICE core (e.g., the ICE core 100 of FIG. 1). A suitable thickness for an optically thin stress relief layer 107 is approximately 1 nm to 2 nm, but could be more or less, depending on the materials used. The stress relief layer 107 may prove advantageous in scenarios where the substrate 106 comprises Si and the first layer 102a comprises TiO₂. In such cases, the TiO₂ exhibits significantly different lattice spacing as compared to Si. Depositing the first layer 102a directly on the Si substrate 106 may, therefore, alter the growth rate, crystal structure, and optical properties of the first layer 102a as compared to the remaining layers 102. Accordingly, the stress relief layer 107 may operate to maintain the optical constants of all the layers 102 (including the first layer 102a) at the same level.

Referring now to FIG. 4, with continued reference to FIG. 1, illustrated is a method 400 of fabricating an exemplary ICE core, such as the ICE core 100 of FIG. 1, according to one or more embodiments. The method 400 may include positioning a substrate 106 in an ALD reaction chamber, as at 402. The substrate 106 may comprise any semiconductor material that has a significantly different lattice constant than the material of the high refractive index layers of the ICE core 100 (e.g., the layers 102). In at least one embodiment, the substrate 106 may comprise Si, but may alternatively comprise any of the other materials mentioned herein in conjunction with the substrate 106. A stress relief layer 107 may then be deposited on the substrate 106, as at 404, via a thin film deposition process. In at least one embodiment, the thin film deposition process comprises ALD. As indicated above, the stress relief layer 107 can be optically thin and otherwise thin enough to not significantly change the desired transmission profile of the ICE core 100, while also providing an amorphous pseudo-substrate layer for the subsequent high refractive index materials grown on the substrate 106.

A plurality of layers 102, 104 of high and low refractive index materials may then be alternately deposited on the stress relief layer 107, as at 406, starting with a first layer 102a. In the present embodiment, the plurality of first layers 102, including the first layer 102a, may exhibit a high refractive index, while the plurality of second layers may exhibit a low refractive index. It will be appreciated, however, that the opposite may equally work, without departing from the scope of the disclosure. In some embodiments, the materials of the high refractive index layers 102 may comprise TiO₂, while the materials for the low refractive index layers 104 and the stress relief layer 107 may comprise Al₂O₃. Since the high refractive index materials (i.e., TiO₂) and the Si substrate 106 exhibit significantly different lattice spacing, the Al₂O₃ stress relief layer 107 may prove advantageous in acting as an amorphous pseudo-substrate layer for the first high refractive index layer 102a such that the first high refractive index layer 102a does not directly contact the substrate 106. As a result, all the high refractive index layers 102 (including the first high refractive index layer 102a) may exhibit the same growth rate, crystal structure, and optical properties. Accordingly, the stress relief layer 107 may allow the optical constants of all the high refractive index layers 102 (including the first high refractive index layer 102a) to remain constant, and thereby provide a more predictive ICE core 100.

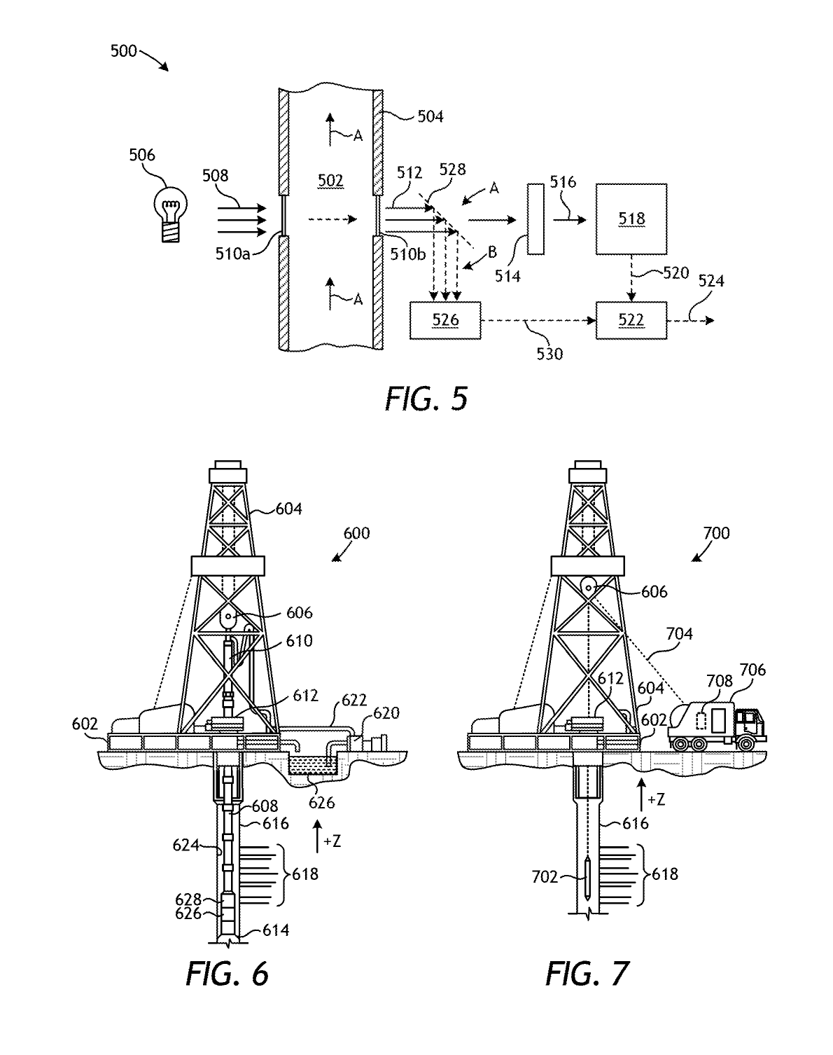

Referring now to FIG. 5, illustrated is a schematic diagram of an exemplary optical computing device 500 that use an ICE core fabricated according to the methods described herein, according to one or more embodiments. The optical computing device 500 may be arranged to monitor a substance 502 contained or otherwise flowing within a flow path 504. In some embodiments, the substance 502 may be flowing within the flow path 504 as indicated by the arrows A. In other embodiments, the substance 502 may be static with in the flow patch 504.

An electromagnetic radiation source 506 may emit or otherwise generate electromagnetic radiation 508. The electromagnetic radiation source 506 may be a light bulb, a light emitting diode (LED), a laser, a blackbody, a photonic crystal, an X-Ray source, a supercontinuum source, combinations thereof, or the like. The electromagnetic radiation 508 may be directed toward the substance 502 and, more particularly, through the substance 502 via a first sampling window 510a and a second sampling window 510b arranged radially opposite the first sampling window 510a on the flow path 504. The first and second sampling windows 510a,b may be arranged adjacent to or otherwise in contact with the substance 502 for detection purposes. The sampling windows 510a,b may be made from a variety of transparent, rigid or semi-rigid materials that are configured to allow transmission of the electromagnetic radiation 508 therethrough. For example, the sampling windows 510a,b may be made of glasses, plastics, semi-conductors, crystalline materials, polycrystalline materials, hot or cold-pressed powders, combinations thereof, or the like.

As the electromagnetic radiation 508 passes through the substance 502 via the first and second sampling windows 510a,b, it optically interacts with the substance 502 and sample interacted radiation 512 is subsequently generated. Those skilled in the art will readily recognize that alternative variations of the device 500 may allow the sample interacted radiation 512 to be generated by being reflected from the substance 502, without departing from the scope of the disclosure.

The sample interacted radiation 512 generated by the interaction with the substance 502 may be directed to or otherwise received by an ICE core 514 arranged within a primary channel A of the device 500. The ICE core 514 may be similar to or the same as the ICE core 100 of FIG. 1 and otherwise fabricated according to the methods described herein. In some embodiments, more than one ICE core 514 may be employed within the primary channel A. Upon optically interacting with the sample interacted radiation 512, the ICE core 514 produces modified electromagnetic radiation 516 that may be detected by a first or primary detector 518. The primary detector 518 may be any device capable of detecting electromagnetic radiation, and may be generally characterized as an optical transducer. For example, the primary detector 518 may be, but is not limited to, a thermal detector such as a thermopile or photoacoustic detector, a semiconductor detector, a piezo-electric detector, a charge coupled device (CCD) detector, a video or array detector, a split detector, a photon detector (such as a photomultiplier tube), photodiodes, combinations thereof, or the like, or other detectors known to those skilled in the art.

The primary detector 518 may then produce an output signal 520 in the form of a voltage (or current) that corresponds to a characteristic of the substance 502, such as a concentration of an analyte present in the substance 502. In at least one embodiment, the output signal 520 produced by the primary detector 518 and a concentration of the characteristic of the substance 502 may be directly proportional. In other embodiments, however, the relationship may correspond to a polynomial function, an exponential function, a logarithmic function, and/or a combination thereof. The output signal 520 may then be conveyed to a signal processor 522 for quantification. The signal processor 522 may be a computer including a processor and a machine-readable storage medium having instructions stored thereon, which, when executed by the processor, cause the device 500 to perform a number of operations, such as determining a characteristic of the substance 502. For instance, the concentration of the characteristic detected with the device 500 can be fed into an algorithm operated by the signal processor 522, and the algorithm can be part of an artificial neural network that uses the concentration of the detected characteristic to evaluate the overall quality of the substance 502. In real-time or near real-time, the signal processor 522 may be programmed to provide a resulting output signal 248 corresponding to the characteristic of interest in the substance 502 as measured by the ICE core 514.

The device 500 may further include a second or reference detector 526 arranged in a reference channel B and configured to receive and otherwise detect at least a portion of the sample interacted radiation 512 as reflected from a beam splitter 528. The reference detector 526 may be similar to the primary detector 518 and capable of detecting electromagnetic radiation. In some embodiments, the reference detector 526 may be used to detect radiating deviations stemming from the electromagnetic radiation source 506 and its optical interaction with the sample substance 502. Radiating deviations can occur in the intensity of the light propagating in the primary channel A due to a wide variety of reasons, such as a film of material build-up on the windows 510a,b, which has the effect of reducing the amount of light reaching the reference detector 526. Another form of radiating deviations encompasses light intensity fluctuations of the electromagnetic radiation 508 as it optically-interacts (e.g., transmission, reflection, etc.) with the substance 502.

The reference detector 526 may be configured to generate a reference signal 530 corresponding to the radiating deviations detected in the reference channel B. In some embodiments, the reference signal 530 may be used to normalize the output signal 520. More particularly, the reference signal 530 and the output signal 520 may be transmitted to or otherwise received by the signal processor 522 in communication with each detector 518, 530. The signal processor 522 may be configured to computationally combine the reference signal 530 with the output signal 520 in order to normalize the output signal 520 in view of any radiating deviations detected by the reference detector 526. In some embodiments, computationally combining the output and reference signals 520, 530 may entail computing a ratio of the two signals 520, 530, thereby essentially computing a ratio of the primary and reference channels A and B (e.g., A/B).

The signal processor 522 may also be configured to further process the output and reference signals 520, 530 in order to provide additional characterization information about the substance 502 being analyzed, such as the identification and concentration of one or more analytes in the substance 502. The concentration of each analyte or the magnitude of each characteristic determined using the optical computing device 200 can be fed into an algorithm run by the signal processor 522. In some embodiments, the algorithm produces the resulting output signal 524 that is readable by an operator or computer.

Referring to FIG. 6, illustrated is an exemplary well drilling system 600 that may employ the optical computing device 500 of FIG. 5, according to one or more embodiments. The well drilling system 600 may provide an illustrative logging while drilling (LWD) environment and the optical computing device 500 may be used to obtain downhole measurements during drilling operations. As illustrated, the well drilling system 600 may include a drilling platform 602 that supports a derrick 604 having a traveling block 606 for raising and lowering a drill string 608. A drill string kelly 610 supports the rest of the drill string 608 as it is lowered through a rotary table 612. The rotary table 612 rotates the drill string 608, thereby turning a drill bit 614 arranged at the end of the drill string 608. As bit 614 rotates, it creates a borehole 616 that passes through various formations 618. A pump 620 circulates drilling fluid through a feed pipe 622 to the kelly 610, downhole through the interior of the drill string 608, through orifices in the drill bit 614, back to the surface via an annulus 624 defined between the drill string 608 and the walls of the borehole 616, and into a retention pit 626. The drilling fluid transports cuttings from the borehole 616 into the pit 626 and aids in maintaining the integrity of the borehole 616.

The drill bit 614 is just one piece of an open-hole LWD assembly that includes one or more drill collars (thick-walled steel pipe) to provide weight and rigidity to aid the drilling process. Some of these drill collars include built-in logging instruments to gather measurements of various drilling parameters such as position, orientation, weight-on-bit, borehole diameter, etc. As an example, a logging tool 626 (such as downhole fluid analysis tool) may be integrated into the bottom-hole assembly near the bit 614. The logging tool 626 may include the optical computing device 500, as described with reference to FIG. 5. Measurements from the tool 626 can be stored in internal memory and/or communicated to the surface. As an example, a telemetry sub 628 may be included in the bottom-hole assembly to maintain a communications link with the surface. Mud pulse telemetry is one common telemetry technique for transferring tool measurements to surface receivers and receiving commands from the surface, but other telemetry techniques can also be used.

Referring to FIG. 7, with continued reference to FIG. 6, illustrated is an exemplary wellbore wireline system 700 that may employ the optical computing device 500 of FIG. 5, according to one or more embodiments. At various times during the drilling process, the drill string 608 (FIG. 6) may be removed from the borehole 616, as shown in FIG. 7. Once the drill string 608 has been removed, logging operations within the borehole 616 can be conducted using a wireline logging tool 702. As illustrated, the wireline logging tool 702 may comprise a sensing instrument sonde suspended by a cable 704 having conductors for transporting power to the tool and telemetry from the tool 702 to the surface. The wireline logging tool 702 may include the optical computing device 500 of FIG. 5 used for detecting characteristics of any fluids or substances within the borehole 616.

A logging facility 706 collects measurements from the logging tool 702, and includes computing facilities 708 for managing logging operations and storing/processing the measurements gathered by the logging tool 702. For the logging environments of FIGS. 6 and 7, measured parameters can be recorded and displayed in the form of a log, i.e., a two-dimensional graph showing the measured parameter as a function of tool position or depth. In addition to making parameter measurements as a function of depth, some logging tools also provide parameter measurements as a function of rotational angle.

Embodiments disclosed herein include:

A. An optical computing device that includes an electromagnetic radiation source that emits electromagnetic radiation to optically interact with a substance, an integrated computational element (ICE) core arranged to optically interact with the electromagnetic radiation. The ICE core includes a substrate, a first plurality of thin films alternatingly deposited on the substrate with a second plurality of thin films via a thin film deposition process, wherein the first plurality of thin films is made of one of high or low refractive index materials and the second plurality of thin films is made of the other of the high or the low refractive index materials, and a stress relief layer deposited on the substrate via the thin film deposition process and interposing the substrate and a first layer of the first plurality of thin films, wherein the stress relief layer maintains one or more optical properties of the first plurality of thin films at a constant value. A detector is positioned to receive modified electromagnetic radiation that has optically interacted with the substance and the ICE core and generate an output signal indicative of the characteristic of the substance.

B. A well system that includes a downhole tool extendable within a wellbore, an optical computing device arranged on the downhole tool for detecting a characteristic of a substance within the wellbore, the optical computing device including an electromagnetic radiation source that emits electromagnetic radiation to optically interact with the substance and an integrated computational element (ICE) core and thereby generate modified electromagnetic radiation, and a detector that receives the modified electromagnetic radiation and generates an output signal indicative of the characteristic of the substance. The ICE core includes a substrate, a first plurality of thin films alternatingly deposited on the substrate with a second plurality of thin films via a thin film deposition process, wherein the first plurality of thin films is made of one of high or low refractive index materials and the second plurality of thin films is made of the other of the high or the low refractive index materials, and a stress relief layer deposited on the substrate via the thin film deposition process and interposing the substrate and a first layer of the first plurality of thin films, the first layer operating to maintain one or more optical properties of the first plurality of thin films at a constant value as the electromagnetic radiation optically interacts with the ICE core.

Each of embodiments A and B may have one or more of the following additional elements in any combination: Element 1: wherein the substrate comprises silicon, the first plurality of thin films comprises titanium dioxide, and the second plurality of thin films and the stress relief layer each comprise aluminum oxide. Element 2: wherein the substrate comprises a material selected from the group consisting of silicon, optical glass, silica, sapphire, germanium, zinc selenide, zinc sulfide, diamond, a ceramic, polycarbonate, polymethylmethacrylate, polyvinylchloride, and any combination thereof. Element 3: wherein the high refractive index materials comprise materials selected from the group consisting of titanium dioxide, niobia, niobium, germanium, germania, magnesium fluoride, silicon monoxide, hafnium oxide, zirconium oxide, tantalum pentoxide, and any combination thereof. Element 4: wherein the low refractive index materials comprise materials selected from the group consisting of aluminum oxide, niobia, niobium, germanium, germania, magnesium fluoride, silicon monoxide, hafnium oxide, zirconium oxide, tantalum pentoxide, and any combination thereof. Element 5: wherein a thickness of the stress relief layer ranges from 1 nm to 2 nm. Element 6: wherein a lattice spacing of the substrate is different than a lattice spacing of the first layer. Element 7: wherein the substance is selected from the group consisting of a solid, a particulate solid, a liquid, a gas, a slurry, an emulsion, a powder, a mud, a glass, a mixture, an aqueous fluid, a non-aqueous fluid, an acid, a surfactant, a biocide, a bleach, a corrosion inhibitor, a foaming agent, a breaker, a scavenger, a stabilizer, a clarifier, a detergent, a treatment fluid, a fracturing fluid, a formation fluid, and any oilfield fluid, chemical, or substance found in the oil and gas industry. Element 8: wherein the electromagnetic radiation source comprises a source selected from the group consisting of a light bulb, a light emitting diode, a laser, a blackbody radiator, a photonic crystal, an X-Ray source, a supercontinuum source, and any combination thereof. Element 9: wherein the detector is selected from the group consisting of a thermal detector, a semiconductor detector, a piezo-electric detector, a charge coupled device detector, a video or array detector, a split detector, a photon detector, photodiodes, and any combination thereof. Element 10: wherein the detector is a first detector and the optical computing device further comprises a second detector arranged to optically interact with the electromagnetic radiation and generate a reference signal indicative of radiating deviations, and a signal processor communicably coupled to the first and second detectors to computationally combine the output signal and the reference signal and thereby normalize the output signal in view of the radiating deviations. Element 11: wherein the thin film deposition process is a process selected from the group consisting of atomic layer deposition, physical vapor deposition, chemical vapor deposition, sputtering, pulsed laser deposition, chemical solution deposition, plasma enhanced chemical vapor deposition, cathodic arc deposition, electrohydrodynamic deposition, electron beam deposition, ion-assisted electron-beam deposition, electrolytic plating, electroless plating, thermal evaporation, chemical evaporation, and molecular beam epitaxy.

Element 12: wherein the downhole tool is arranged on a drill string having a drill bit arranged at an end of the drill string. Element 13: wherein the downhole tool is extendable into the wellbore on wireline. Element 14: wherein the substrate comprises silicon, the first plurality of thin films comprises titanium dioxide, and the second plurality of thin films and the stress relief layer each comprise aluminum oxide. Element 15: wherein the high refractive index materials comprise materials selected from the group consisting of titanium dioxide, niobia, niobium, germanium, germania, magnesium fluoride, silicon monoxide, hafnium oxide, zirconium oxide, tantalum pentoxide, and any combination thereof. Element 16: wherein the low refractive index materials comprise materials selected from the group consisting of aluminum oxide, niobia, niobium, germanium, germania, magnesium fluoride, silicon monoxide, hafnium oxide, zirconium oxide, tantalum pentoxide, and any combination thereof. Element 17: wherein a thickness of the stress relief layer ranges from 1 nm to 2 nm. Element 18: wherein the detector is a first detector and the optical computing device further comprises a second detector arranged to optically interact with the electromagnetic radiation and generate a reference signal indicative of radiating deviations, and a signal processor communicably coupled to the first and second detectors to computationally combine the output signal and the reference signal and thereby normalize the output signal in view of the radiating deviations. Element 19: wherein the thin film deposition process is a process selected from the group consisting of atomic layer deposition, physical vapor deposition, chemical vapor deposition, sputtering, pulsed laser deposition, chemical solution deposition, plasma enhanced chemical vapor deposition, cathodic arc deposition, electrohydrodynamic deposition, electron beam deposition, ion-assisted electron-beam deposition, electrolytic plating, electroless plating, thermal evaporation, chemical evaporation, and molecular beam epitaxy.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. An optical computing device, comprising:
an electromagnetic radiation source that emits electromagnetic radiation to optically interact with a substance;
an integrated computational element (ICE) core arranged to optically interact with the electromagnetic radiation, the ICE core including:
a substrate;
a first plurality of thin films alternatingly deposited on the substrate with a second plurality of thin films via a thin film deposition process, wherein the first plurality of thin films is made of one of high or low refractive index materials and the second plurality of thin films is made of the other of the high or the low refractive index materials; and
a stress relief layer deposited on the substrate via the thin film deposition process and interposing the substrate and a first layer of the first plurality of thin films, wherein the stress relief layer maintains one or more optical properties of the first plurality of thin films at a constant value; and
a detector positioned to receive modified electromagnetic radiation that has optically interacted with the substance and the ICE core and generate an output signal indicative of the characteristic of the substance.

2. The optical computing device of claim 1, wherein the substrate comprises silicon, the first plurality of thin films comprises titanium dioxide (TiO₂), and the second plurality of thin films and the stress relief layer each comprise aluminum oxide (Al₂O₃).

3. The optical computing device of claim 1, wherein the substrate comprises a material selected from the group consisting of silicon, optical glass, silica, sapphire, germanium, zinc selenide, zinc sulfide, diamond, a ceramic, polycarbonate, polymethylmethacrylate, polyvinylchloride, and any combination thereof.

4. The optical computing device of claim 1, wherein the high refractive index materials comprise materials selected from the group consisting of titanium dioxide, niobia, niobium, germanium, germania, magnesium fluoride, silicon monoxide, hafnium oxide, zirconium oxide, tantalum pentoxide, and any combination thereof.

5. The optical computing device of claim 1, wherein the low refractive index materials comprise materials selected from the group consisting of aluminum oxide, niobia, niobium, germanium, germania, magnesium fluoride, silicon monoxide, hafnium oxide, zirconium oxide, tantalum pentoxide, and any combination thereof.

6. The optical computing device of claim 1, wherein a thickness of the stress relief layer ranges from 1 nm to 2 nm.

7. The optical computing device of claim 1, wherein a lattice spacing of the substrate is different than a lattice spacing of the first layer.

8. The optical computing device of claim 1, wherein the substance is selected from the group consisting of a solid, a particulate solid, a liquid, a gas, a slurry, an emulsion, a powder, a mud, a glass, a mixture, an aqueous fluid, a non-aqueous fluid, an acid, a surfactant, a biocide, a bleach, a corrosion inhibitor, a foaming agent, a breaker, a scavenger, a stabilizer, a clarifier, a detergent, a treatment fluid, a fracturing fluid, a formation fluid, and any oilfield fluid, chemical, or substance found in the oil and gas industry.

9. The optical computing device of claim 1, wherein the electromagnetic radiation source comprises a source selected from the group consisting of a light bulb, a light emitting diode, a laser, a blackbody radiator, a photonic crystal, an X-Ray source, a supercontinuum source, and any combination thereof.

10. The optical computing device of claim 1, wherein the detector is selected from the group consisting of a thermal detector, a semiconductor detector, a piezo-electric detector, a charge coupled device detector, a video or array detector, a split detector, a photon detector, photodiodes, and any combination thereof.

11. The optical computing device of claim 1, wherein the detector is a first detector and the optical computing device further comprises:
a second detector arranged to optically interact with the electromagnetic radiation and generate a reference signal indicative of radiating deviations; and
a signal processor communicably coupled to the first and second detectors to computationally combine the output signal and the reference signal and thereby normalize the output signal in view of the radiating deviations.

12. The optical computing device of claim 1, wherein the thin film deposition process is a process selected from the group consisting of atomic layer deposition, physical vapor deposition, chemical vapor deposition, sputtering, pulsed laser deposition, chemical solution deposition, plasma enhanced chemical vapor deposition, cathodic arc deposition, electrohydrodynamic deposition, electron beam deposition, ion-assisted electron-beam deposition, electrolytic plating, electroless plating, thermal evaporation, chemical evaporation, and molecular beam epitaxy.

13. A well system, comprising:
a downhole tool extendable within a wellbore;
an optical computing device arranged on the downhole tool for detecting a characteristic of a substance within the wellbore, the optical computing device including an electromagnetic radiation source that emits electromagnetic radiation to optically interact with the substance and an integrated computational element (ICE) core and thereby generate modified electromagnetic radiation, and a detector that receives the modified electromagnetic radiation and generates an output signal indicative of the characteristic of the substance, wherein the ICE core includes:
a substrate;
a first plurality of thin films alternatingly deposited on the substrate with a second plurality of thin films via a thin film deposition process, wherein the first plurality of thin films is made of one of high or low refractive index materials and the second plurality of thin films is made of the other of the high or the low refractive index materials; and
a stress relief layer deposited on the substrate via the thin film deposition process and interposing the substrate and a first layer of the first plurality of thin films, the first layer operating to maintain one or more optical properties of the first plurality of thin films at a constant value as the electromagnetic radiation optically interacts with the ICE core.

14. The well system of claim 13, wherein the downhole tool is arranged on a drill string having a drill bit arranged at an end of the drill string.

15. The well system of claim 13, wherein the downhole tool is extendable into the wellbore on wireline.

16. The well system of claim 13, wherein the substrate comprises silicon, the first plurality of thin films comprises titanium dioxide (TiO₂), and the second plurality of thin films and the stress relief layer each comprise aluminum oxide (Al₂O₃).

17. The well system of claim 13, wherein the high refractive index materials comprise materials selected from the group consisting of titanium dioxide, niobia, niobium, germanium, germania, magnesium fluoride, silicon monoxide, hafnium oxide, zirconium oxide, tantalum pentoxide, and any combination thereof.

18. The well system of claim 13, wherein the low refractive index materials comprise materials selected from the group consisting of aluminum oxide, niobia, niobium, germanium, germania, magnesium fluoride, silicon monoxide, hafnium oxide, zirconium oxide, tantalum pentoxide, and any combination thereof.

19. The well system of claim 13, wherein a thickness of the stress relief layer ranges from 1 nm to 2 nm.

20. The well system of claim 13, wherein the detector is a first detector and the optical computing device further comprises:
a second detector arranged to optically interact with the electromagnetic radiation and generate a reference signal indicative of radiating deviations; and
a signal processor communicably coupled to the first and second detectors to computationally combine the output signal and the reference signal and thereby normalize the output signal in view of the radiating deviations.

21. The well system of claim 13, wherein the thin film deposition process is a process selected from the group consisting of atomic layer deposition, physical vapor deposition, chemical vapor deposition, sputtering, pulsed laser deposition, chemical solution deposition, plasma enhanced chemical vapor deposition, cathodic arc deposition, electrohydrodynamic deposition, electron beam deposition, ion-assisted electron-beam deposition, electrolytic plating, electroless plating, thermal evaporation, chemical evaporation, and molecular beam epitaxy.
